(19) United States
(12) Patent Application Publication
(10) Pub. No.: US 2015/0002043 A1
(43) Pub. Date: Jan. 1, 2015

(54) POWER SUPPLY APPARATUS AND CONTROL CIRCUIT THEREOF

(71) Applicants: University of Seoul Industry Cooperation Foundation, Seoul (KR); SAMSUNG ELECTRO-MECHANICS CO., LTD., Suwon (KR)

(72) Inventors: Dae Hoon HAN, Suwon (KR); Seo Hyung KIM, Suwon (KR); Seung Ryung RYU, Suncheon (KR); Joong Ho CHOI, Seongnam (KR); Hong Jin KIM, Seoul (KR); Joo Hyung LEE, Seoul (KR); Jae Shin LEE, Suwon (KR); Kang Yoon LEE, Seoul (KR)

(73) Assignees: University of Seoul Industry Cooperation Foundation, Seoul (KR); SAMSUNG ELECTRO-MECHANICS CO., LTD., Suwon (KR)

(21) Appl. No.: 14/063,744

(22) Filed: Oct. 25, 2013

(30) Foreign Application Priority Data
Jun. 28, 2013 (KR) 10-2013-0076010

(51) Int. Cl. H05B 33/08

(52) U.S. Cl. CPC H05B 33/0815
USPC 315/223

(57) ABSTRACT

There are provided a power supply apparatus switching a power input to a primary side to supply the power to a predetermined load connected to a secondary side electrically insulated from the primary side and a control circuit thereof, the control circuit generating a predetermined PWM signal to apply the generated PWM signal to a dimming switch connected to an end of the load and controlling a switching frequency of the primary side based on a control voltage generated according to a feedback signal depending on the power supplied to the load and the PWM signal, wherein a voltage variation amount of the control voltage may be constantly maintained regardless of a duty of the PWM signal.

### CROSS-REFERENCE TO RELATED APPLICATIONS

This application claims the priority of Korean Patent Application No. 10-2013-0076010 filed on Jun. 28, 2013, in the Korean Intellectual Property Office, the disclosure of which is incorporated herein by reference.

### BACKGROUND OF THE INVENTION

1. Field of the Invention

The present invention relates to a power supply apparatus having multiple outputs supplying power to a light emitting diode (LED), and a control circuit thereof.

2. Description of the Related Art

Recently, in the field of displays, a display apparatus mainly using a cathode ray tube (CRT) has been replaced by a flat panel display (FPD) apparatus reflecting user demands for features such as high resolution, large screens, and the like.

Particularly, in the case of a large display apparatus, a liquid crystal display (LCD) apparatus has rapidly grown in size due to advantages thereof in view of lightness and slimness and is expected to play a leading role in the field of displays in view of the cost and marketability thereof.

Meanwhile, in an existing liquid crystal display apparatus, a cold cathode fluorescent lamp (CCFL) has mainly been used as a backlight light source. However, recently, a light emitting diode (LED) has been gradually used as the backlight light source due to various advantages thereof, such as low power consumption, a relatively long lifespan, environmental friendliness, and the like.

In order to drive the light emitting diode, a power supplying circuit converting commercial alternating current (AC) power into direct current (DC) power and a driving circuit controlling the supplying of the DC power to the light emitting diode are generally used.

The power supplying circuit may be divided into a primary side and a secondary side based on a transformer in order to enhance an insulation function, wherein the primary side is configured of a circuit rectifying and smoothing the commercial AC power to switch the power and the secondary side is configured of a circuit rectifying power transformed by the transformer and controlling a supplement of the rectified power to a load.

That is, as disclosed in the following Related Art Document, generally, a power switching control circuit is formed on the primary side and the above-mentioned driving circuit is formed on the secondary side. In this configuration, in order to smoothly control switching of the power, information on a state of the power supplied to the light emitting diode should be feedbacked and the switching of the power should be controlled based on the information. To this end, a photo coupler having an insulation function to transfer a feedback current is mainly used. However, since the photo coupler is an optical device, signal transfer characteristics depend on photons, a use period, and a junction temperature; such that a circuit design may be complicated and manufacturing costs may be increased due to use of the photo coupler.

In order to solve these problems, the power switching control circuit and the driving circuit may be formed on the secondary side. However, in this configuration using a scheme of receiving feedback regarding a state of power on the secondary side to control the switching on the secondary side, it is difficult to control precisely a switching frequency. Further, instead of not using the photo coupler, since a non-linear device such as a transistor for receiving and directly using the feedback on the power state on the secondary side should be additionally used, manufacturing costs may still be increased.

### RELATED ART DOCUMENT

(Patent Document 1) Korean Patent Laid-Open Publication No. 10-2012-0006392

### SUMMARY OF THE INVENTION

An aspect of the present invention provides a power supply apparatus capable of precisely controlling a switching frequency of a primary side on a secondary side by receiving feedback regarding a state of power on the secondary side without using a separate expensive device or a complicated circuit.

According to an aspect of the present invention, there is provided a control circuit of a power supply apparatus switching a power input to a primary side to supply the power to a predetermined load connected to a secondary side electrically insulated from the primary side, wherein the control circuit generates a predetermined PWM signal to apply the generated PWM signal to a dimming switch connected to an end of the load and controls a switching frequency of the primary side based on a control voltage generated according to a feedback signal depending on the power supplied to the load and the PWM signal, wherein a voltage variation amount of the control voltage is constantly maintained regardless of a duty of the PWM signal.

The control circuit may include: a dimming unit applying the PWM signal to the dimming switch and generating the control voltage; a current generating unit generating a current having a current amount varied according to a level of the control voltage of the dimming unit; a signal generating unit generating a pulse signal having a frequency determined depending on the current generated by the current generating unit; and a driving unit generating a switching control signal according to the pulse signal.

The current generating unit may include: a plurality of resistors; a first comparator comparing a preset first reference voltage and a voltage according to a current flowing in the plurality of resistors with each other; a current adjusting switch adjusting a current amount of the current flowing in the plurality of resistors according to an output signal of the first comparator; and a current mirror mirroring the current flowing in the plurality of resistors to transfer the mirrored current to the signal generating unit, wherein the current flowing in at least one of the plurality of resistors has the current amount varied according to the control voltage generated from the dimming unit.

The first comparator may include a non-inverting terminal to which the first reference voltage is applied; the current adjusting switch may include a transistor having a gate connected to an output terminal of the first comparator, a source connected to an inverting terminal of the first comparator, and a drain connected to the current mirror; and a portion of the plurality of resistors may be provided between the inverting terminal of the first comparator and a ground, and the remainder of the plurality of resistors may be provided between the non-inverting terminal of the first comparator and a output node of the dimming unit.

The dimming unit may include: a PWM signal generator applying the PWM signal to the dimming switch; a second comparator comparing a level of the feedback signal and a predetermined target power level with each other; a first capacitor having one end connected to a ground and charged or discharged according to an output signal of the second comparator; a first switch disposed between an output terminal of the second comparator and the other end of the first capacitor; a third comparator comparing a voltage charged in the first capacitor and a preset second reference voltage with each other; a compensating unit generating a current compensating for the voltage charged in the first capacitor according to an output signal of the third comparator; and a second switch disposed between the compensating unit and the other end of the first capacitor, wherein the first switch may perform a switching operation according to the PWM signal, the second switch may perform a switching operation according to a signal inverting the PWM signal, and the charged voltage of the first capacitor may be used as the control voltage.

The control circuit may further include a hetero-junction bipolar transistor having a base to which the charged voltage of the first capacitor is applied, a collector connected to a driving power terminal, and an emitter, wherein the control circuit may use a voltage output from the emitter as the control voltage.

The control circuit may further include a buffer buffering the voltage output from the emitter.

The control circuit may further include a voltage dividing unit dividing the voltage output from the emitter to provide the divided voltage to the buffer.

The signal generating unit may include: a second capacitor charged or discharged by the current output from the current generating unit; a charging or discharging switch disposed to be parallel to the second capacitor; a first comparing unit comparing a preset third reference voltage and a voltage charged in the second capacitor with each other to control a switching operation of the charging or discharging switch; and a second comparing unit comparing the charged voltage of the second capacitor and a preset fourth reference voltage to generate the pulse signal.

According to another aspect of the present invention, there is provided a power supply apparatus, including: a power supplying unit switching a power input to a primary side to supply the power to a predetermined load connected to a secondary side electrically insulated from the primary side; and a controlling unit applying a predetermined PWM signal to a dimming switch connected to an end of the load and controlling a switching frequency of the primary side based on a control voltage generated according to a feedback signal depending on the power supplied to the load and the PWM signal, wherein a voltage variation amount of the control voltage is constantly maintained regardless of a duty of the PWM signal.

The power supplying unit may include: a switching unit including at least two switches connected in series between an input power terminal to which the input power is input and a ground; a transforming unit transforming a voltage level of the power switched by the switching unit; a first outputting unit stabilizing the power output from the transforming unit to output a preset first power; and a second outputting unit stabilizing the power output from the transforming unit to output a preset second power.

The transforming unit may include: a resonance tank providing an inductor-inductor-capacitor (LLC) resonance operation of the switching unit; and a transformer having a primary winding receiving the switched power of the switching unit, and a first secondary winding and a second secondary winding each forming a preset turns ratio with the primary winding and each outputting the first power or the second power.

The power supplying unit may further include: a rectifying and smoothing unit rectifying and smoothing an alternating current (AC) power; and a power factor correcting unit performing a power factor correction on a direct current (DC) power from the rectifying and smoothing unit to supply the corrected DC power to the switching unit.

The first power may be supplied to at least one light emitting diode channel.

The controlling unit may control the switching frequency according to a power state of the power supplying unit to control a power state of the first power and may control a switching duty to control a power state of the second power.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram schematically showing a power supply apparatus according to an embodiment of the present invention;

FIG. 2 is a circuit diagram schematically showing a controlling unit used in the power supply apparatus according to the embodiment of the present invention;

FIG. 3 is a graph showing signal waveforms of a signal generating unit used in the power supply apparatus according to the embodiment of the present invention;

FIG. 4 is a circuit diagram schematically showing a current generating unit used in the power supply apparatus according to the embodiment of the present invention;

FIG. 5 is a circuit diagram schematically showing a dimming unit used in the power supply apparatus according to the embodiment of the present invention;

FIG. 6 is a graph showing signal waveforms of main components used in the power supply apparatus according to the embodiment of the present invention; and

FIGS. 7 and 8 are simulation data for describing an effect of the power supply apparatus according to the embodiment of the present invention.

### DETAILED DESCRIPTION OF THE EMBODIMENTS

Hereinafter, embodiments of the present invention will be described in detail. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

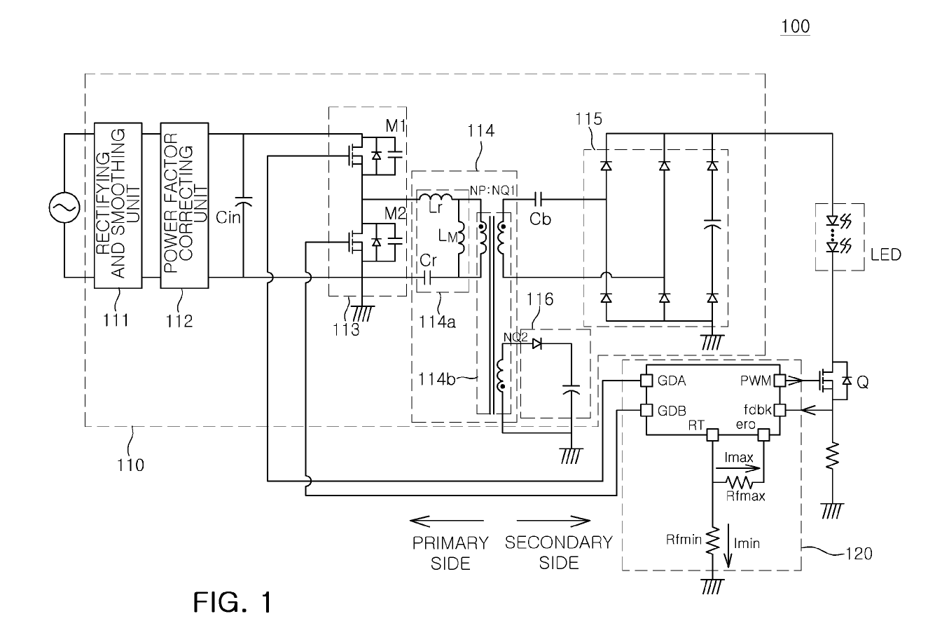

FIG. 1 is a circuit diagram schematically showing a power supply apparatus according to an embodiment of the present invention. Referring to FIG. 1, a power supply apparatus 100 according to the embodiment of the present invention may include a power supplying unit 110 and a controlling unit 120.

The power supplying unit 110 may include a switching unit 113, a transforming unit 114, and a first outputting unit 115, and further include a rectifying and smoothing unit 111, a power factor correcting unit 112, and a second outputting unit 116.

The rectifying and smoothing unit 111 may rectify and smooth an alternating current (AC) power to generate a direct current (DC) power and transfer the DC power to the power factor correcting unit 112, and the power factor correcting unit 112 may adjust a phase difference between a voltage and a current of the DC power from the rectifying and smoothing unit 111 to correct a power factor of the power.

The switching unit 113 may include at least two switches M1 and M2 stacked between an input power terminal to which the DC power from the power factor correcting unit 112 is input and a ground and perform a power conversion operation by an alternate switching operation of the switch M1 and the switch M2.

The transforming unit 114 may include a resonance tank 114a and a transformer 114b, wherein the resonance tank 114a may provide an inductor-inductor-capacitor (Lr-Lm-Cr) (LLC) resonance operation. Here, one (Lm) of the inductors may be a magnetizing inductor of the transformer 114b.

The transformer 114b may include a primary winding P and secondary windings Q1 and Q2, wherein the primary winding P and the secondary windings Q1 and Q2 may be electrically insulated from each other. That is, the primary winding P and the secondary windings Q1 and Q2 may have different electrical properties in terms of grounds thereof.

More specifically, the rectifying and smoothing unit 111, the power factor correcting unit 112, the switching unit 113, the resonance tank 114a, and the primary winding P of the transformer 114b may be formed on the primary side, and the secondary windings Q1 and Q2 of the transformer 114b, the first and second outputting units 115 and 116, and the controlling unit 120 may be formed on the secondary side.

The primary winding P and the secondary windings Q1 and Q2 may form a preset turns ratio, and the secondary windings Q1 and Q2 may vary a voltage level according to the turn ratio and output power having the varied voltage level.

The first outputting unit 115 may rectify and stabilize a first power from the first secondary winding Q1 to output the power, and supply the power to a predetermined load, particularly, to at least one light emitting diode (LED) channel. The second outputting unit 116 may rectify and stabilize a second power from the second secondary winding Q2 to output the power.

The controlling unit 120 may be formed on the secondary side and receive feedback regarding a state of the power of the first outputting unit 115 to control a switching frequency of the switching unit 113 positioned on the primary side. More specifically, the first power of the first outputting unit 115 may be supplied to a load LED to apply a PWM signal to a dimming switch Q positioned between an end of the load LED and the ground, thereby adjusting a current flowing in the load LED, and a power level of the first power may be controlled by controlling the switching frequency of the switching unit 113 according to a feedback signal fdbk generated by detecting the current flowing in the load LED and the PWM signal.

In this case, the controlling unit 120 may provide switching control signals GDA and GDB controlling a minimum value and a maximum value of the switching frequency of the switching unit 113 based on a current flowing in first and second resistor Rfmin and Rfmax.

Meanwhile, the controlling unit 120 may control the switching frequency of the switching unit 113 to control the power level of the first power and control a switching duty of the switching unit 113 to control a power level of the second power.

Since a technology of controlling the power level of the first power using the switching frequency and controlling the power level of the second power using the switching duty through a single control circuit and a single switching circuit at the time of multiple outputs in the power supply apparatus is well-known in the art, a detailed description thereof will be omitted.

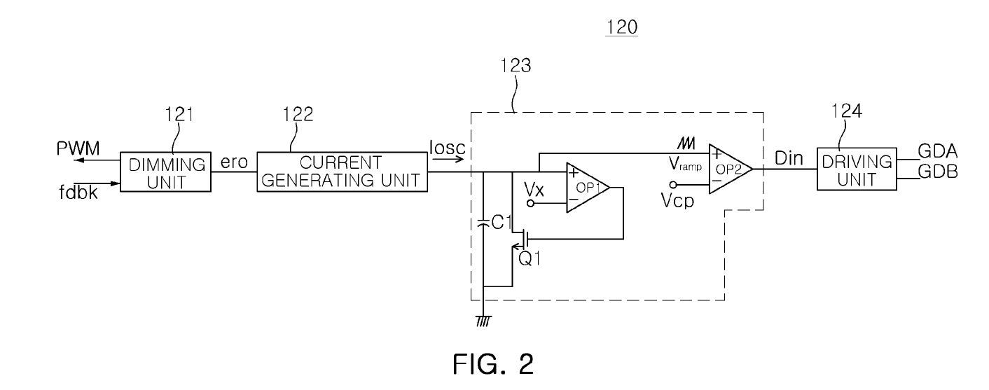

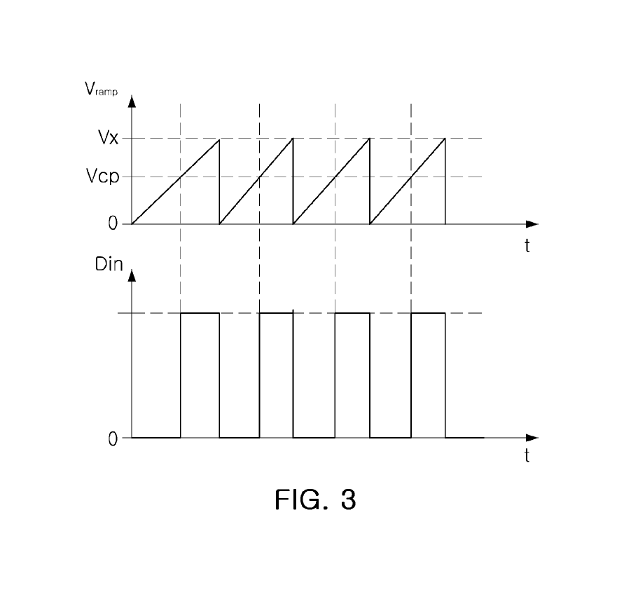

FIG. 2 is a circuit diagram schematically showing a controlling unit used in the power supply apparatus according to the embodiment of the present invention and FIG. 3 is a graph showing signal waveforms of a signal generating unit used in the power supply apparatus according to the embodiment of the present invention.

Referring to FIG. 2, the controlling unit 120 may include a dimming unit 121, the first and second resistors Rfmin and Rfmax, a current generating unit 122, a signal generating unit 123, and a driving unit 124.

The dimming unit 121 may include a PWM signal generating circuit to apply the PWM signal to the dimming switch Q positioned between an end of the load LED of the secondary side and the ground, thereby adjusting the current flowing in the load LED. In addition, the dimming unit 121 is connected to the current generating unit 122 through a node ero and adjusts a voltage Vero of the node ero according to the PWM signal and the fdbk signal.

The current generating unit 122 may include the first and second resistors Rfmin and Rfmax shown in FIG. 1 and may transfer a current Iosc generated by mirroring the current flowing through the first and the second resistors Rfmin and Rfmax to the signal generating unit 123.

A detailed configuration and operation of the dimming unit 121 and the current generating unit 122 will be described below.

The signal generating unit 123 may include a capacitor C1, a charging or discharging switch Q1, a first comparator op1, and a second comparator op2 and generate a sawtooth signal according to a voltage charged in or discharged from the capacitor C1. More specifically, the capacitor C1 may be supplied with the current from the current generating unit 122 and may be charged or discharged according to a switching operation of the charging or discharging switch Q1. In addition, the first comparator op1 may compare a preset reference voltage Vx and a voltage charged in the capacitor C1 with each other and control the switching operation of the charging or discharging switch Q1 according to the comparison result.

Therefore, the voltage of the capacitor C1 may have a form such as a sawtooth signal Vramp as shown in FIG. 3, and the second comparator op2 may compare the sawtooth signal Vramp and a preset reference voltage Vcp with each other and provide a pulse signal Din to the driving unit 124.

The driving unit 124 may provide the switching control signals GDA and GDB capable of driving switches M1 and M2 of the switching unit 113 based on the pulse signal Din from the second comparator op2. In this case, the switching control signal GDA may be the same signal as the pulse signal Din and the switching control signal GDB may correspond to a signal formed by inverting the switching control signal GDB.

Meanwhile, a level of the current Iosc from the current generating unit 122 may control a time for which the current is charged in the capacitor C1. Therefore, frequencies of the switching control signals GDA and GDB may be controlled.

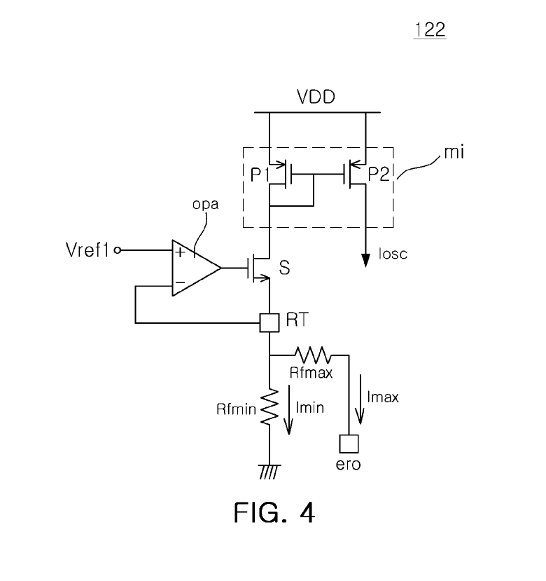

FIG. 4 is a circuit diagram schematically showing a current generating unit used in the power supply apparatus according to the embodiment of the present invention.

Referring to FIG. 4, the current generating unit 122 may include a current mirror mi configured of two transistors P1 and P2, a first comparator opa, a current adjusting switch S, and the first and second resistors Rfmin and Rfmax. The current mirror mi may mirror the current flowing in the first and second resistors Rfmin and Rfmax and supply the mirrored current to the signal generating unit 123.

Specifically, the first comparator opa may compare a preset first reference voltage Vref1 and a voltage (a voltage at a node RT) according to the current flowing in the first and second resistors Rfmin and Rfmax with each other and control a switching operation of the current adjusting switch S according to the comparison result to control the current flowing in the first and second resistors Rfmin and Rfmax. Describing in detail, when the voltage at the RT node is higher than the first reference voltage Vref1, an output voltage of the first comparator opa is decreased. Therefore, an amount of a current flowing through the current adjusting switch S is decreased. Here, when the decreased current flows through the first and second resistors Rfmin and Rfmax, a voltage drop is generated and the voltage at the RT node is decreased. On the other hand, when the voltage at the RT node is lower than the first reference voltage Vref1, the output voltage of the first comparator opa is increased. Therefore, the amount of the current flowing through the current adjusting switch S is increased. Here, the increased current flows through the first and second resistors Rfmin and Rfmax and the voltage at the RT node is increased.

Currents Imin and Imax may be generated due to the voltage at the RT node and the first and second resistors Rfmin and Rfmax, wherein current amounts of the currents Imin and Imax may be varied according to magnitudes of the first and second resistors Rfmin and Rfmax. In this case, since the first resistor Rfmin is connected to a ground and the second resistor Rfmax is connected to the node ero, the total resistance value may be changed according to the voltage of the node ero and the total current amount may be varied.

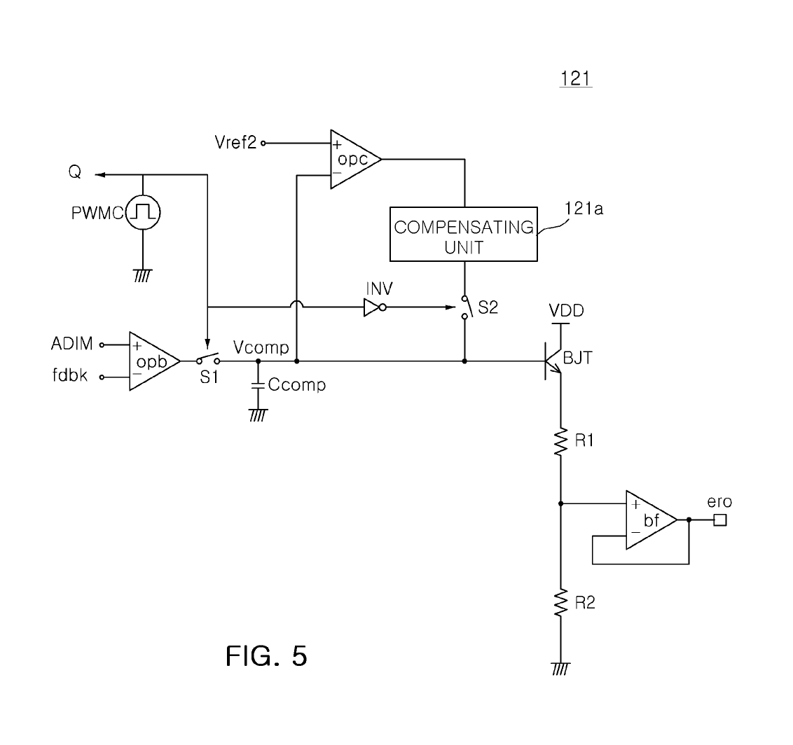

FIG. 5 is a circuit diagram schematically showing a dimming unit used in the power supply apparatus according to the embodiment of the present invention. As shown in FIG. 5, the dimming unit 121 may include a second comparator opb, a third comparator opc, switches S1 and S2, a capacitor Ccomp, an inverter INV, and a PWM signal generator PWMC, and further include a hetero-junction bipolar transistor (BJT), at least two resistors R1 and R2, and a buffer bf.

In the following description, when a PWM signal generated from the PWM signal generator PWMC is at a high level, the switch S1 is turned-on and the switch S2 is turned-off and when the PWM signal is at a low level, the switch S1 is turned-off and the switch S2 is turned-on.

When the PWM signal is at a high level, the second comparator opb compares a target power level ADIM and a signal level of the feedback signal fdbk detected from the current flowing in the load LED with each other, and the capacitor Ccomp is charged according to the comparison result to generate a voltage Vcomp. The voltage Vcomp is transferred to the resistors R1 and R2 through the hetero-junction bipolar transistor (BJT) having an emitter follower structure and divided voltages divided by the resistors R1 and R2 are buffered by the buffer bf to be provided to the node ero. By configuring the hetero-junction bipolar transistor (BJT) to have the emitter follower structure, an influence of noise introduced through the ground, on the voltage Vcomp, may be minimized.

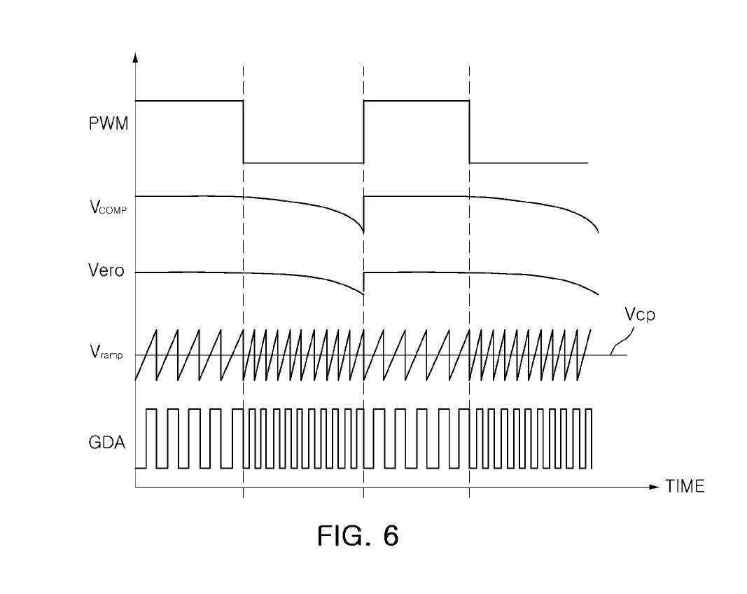

More specifically, describing with reference to FIGS. 5 and 6, when the signal level of the feedback signal fdbk is lower than the target power level ADIM, a level of the voltage Vcomp is increased according to the comparison result of the second comparator opb. Therefore, the voltage level Vero in an output terminal of the buffer bf is increased. Since the current Imin flowing in the first resistor Rfmin is fixed, the current Imax flowing in the second resistor Rfmax is gradually decreased, such that the frequencies of the switching control signals GDA and GDB may become high and the voltage level of the first power may be increased.

On the contrary, when the signal level of the feedback signal fdbk is higher than the target power level ADIM, the voltage level of the voltage Vcomp is decreased according to the comparison result of the second comparator opb, such that the voltage level Vero in the output terminal of the buffer bf may also be decreased. Therefore, the current Imax flowing in the second resistor Rfmax is gradually increased, such that the frequencies of the switching control signals GDA and GDB may be high and the voltage level of the first power may be decreased. The above-mentioned operations are repeated, such that a targeted output voltage of the first power may be regulated.

When the PWM signal is at a low level, the current does not flow in the load LED, such that the voltage level of the first power may be increased. In order to decrease the voltage level of the first power, the switch S1 is turned-off and the capacitor Ccomp is slowly discharged, such that the voltage level of the voltage Vcomp is slowly decreased. As the Vcomp is slowly decreased, the voltage level Vero of the node ero is decreased and the frequencies of the switching control signals GDA and GDB may become high, such that the voltage level of the first power may be decreased.

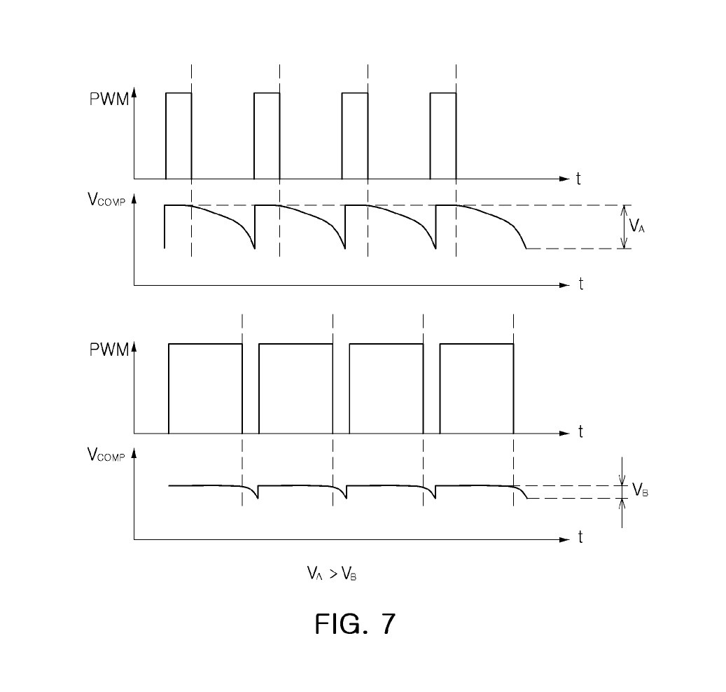

Meanwhile, when the PWM signal is at a low level, the switch S1 is turned-off and the voltage Vcomp is decreased. Here, when a duty of the PWM signal is changed, a low level interval thereof is changed, such that a difference in dropped voltage levels is generated as shown in FIG. 7. When such a voltage drop is large, the frequencies of the switching control signals GDA and GDB may be significantly changed. Asa result, the voltage level of the first power is also changed, such that it may be outside of a required specification of a system.

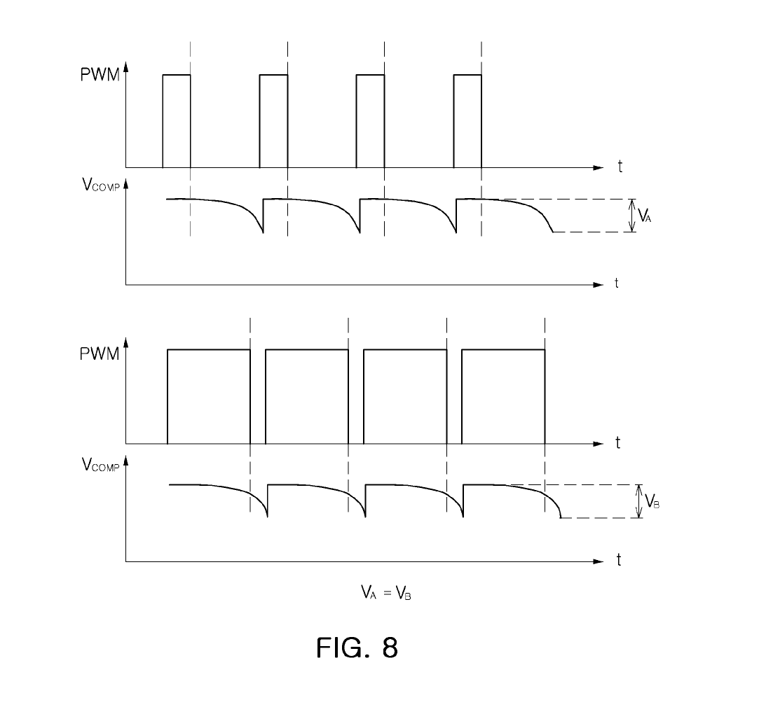

According to the embodiment of the present invention, the above-mentioned limitations are solved using the switch S2, the third comparator opc, the inverter INV, and a compensating unit 121a. The third comparator opc compares a predetermined second reference voltage Vref2 and the voltage Vcomp with each other to detect whether the voltage Vcomp is decreased when the PWM signal is at a low level. When the level of the voltage Vcomp is lower than that of the second reference voltage Vref2, an up signal for increasing the voltage Vcomp is output and the compensating unit 121a outputs a current according to the up signal to increase the voltage Vcomp. Therefore, as shown in FIG. 8, when the PWM signal is at a low level, a voltage variation amount of the voltage Vcomp may be constantly maintained regardless of the duty of the PWM signal.

As set forth above, according to the embodiments of the present invention, the switching frequency of the primary side on the secondary side is controlled using an external resistor without using a separate expensive device or a complicated circuit, whereby a circuit can be simplified and a manufacturing cost thereof can be decreased.

While the present invention has been shown and described in connection with the embodiments, it will be apparent to those skilled in the art that modifications and variations can be made without departing from the spirit and scope of the invention as defined by the appended claims.

What is claimed is:

1. A control circuit of a power supply apparatus switching a power input to a primary side to supply the power to a predetermined load connected to a secondary side electrically insulated from the primary side,
wherein the control circuit generates a predetermined PWM signal to apply the generated PWM signal to a dimming switch connected to an end of the load and controls a switching frequency of the primary side based on a control voltage generated according to a feedback signal depending on the power supplied to the load and the PWM signal, wherein a voltage variation amount of the control voltage is constantly maintained regardless of a duty of the PWM signal.

2. The control circuit of claim 1, comprising:
a dimming unit applying the PWM signal to the dimming switch and generating the control voltage;
a current generating unit generating a current having a current amount varied according to a level of the control voltage of the dimming unit;
a signal generating unit generating a pulse signal having a frequency determined depending on the current generated by the current generating unit; and
a driving unit generating a switching control signal according to the pulse signal.

3. The control circuit of claim 2, wherein the current generating unit includes:
a plurality of resistors;
a first comparator comparing a preset first reference voltage and a voltage according to a current flowing in the plurality of resistors with each other;
a current adjusting switch adjusting a current amount of the current flowing in the plurality of resistors according to an output signal of the first comparator; and
a current mirror mirroring the current flowing in the plurality of resistors to transfer the mirrored current to the signal generating unit,
wherein the current flowing in at least one of the plurality of resistors has the current amount varied according to the control voltage generated from the dimming unit.

4. The control circuit of claim 3, wherein the first comparator includes a non-inverting terminal to which the first reference voltage is applied;
the current adjusting switch includes a transistor having a gate connected to an output terminal of the first comparator, a source connected to an inverting terminal of the first comparator, and a drain connected to the current mirror; and
a portion of the plurality of resistors is provided between the inverting terminal of the first comparator and a ground, and the remainder of the plurality of resistors is provided between the non-inverting terminal of the first comparator and a output node of the dimming unit.

5. The control circuit of claim 2, wherein the dimming unit includes:
a PWM signal generator applying the PWM signal to the dimming switch;
a second comparator comparing a level of the feedback signal and a predetermined target power level with each other;
a first capacitor having one end connected to a ground and charged or discharged according to an output signal of the second comparator;
a first switch disposed between an output terminal of the second comparator and the other end of the first capacitor;
a third comparator comparing a voltage charged in the first capacitor and a preset second reference voltage with each other;
a compensating unit generating a current compensating for the voltage charged in the first capacitor according to an output signal of the third comparator; and
a second switch disposed between the compensating unit and the other end of the first capacitor,
wherein the first switch performs a switching operation according to the PWM signal, the second switch performs a switching operation according to a signal formed by inverting the PWM signal, and the charged voltage of the first capacitor is used as the control voltage.

6. The control circuit of claim 5, further comprising a hetero-junction bipolar transistor having a base to which the charged voltage of the first capacitor is applied, a collector connected to a driving power terminal, and an emitter,
wherein the control circuit uses a voltage output from the emitter as the control voltage.

7. The control circuit of claim 6, further comprising a buffer buffering the voltage output from the emitter.

8. The control circuit of claim 7, further comprising a voltage dividing unit dividing the voltage output from the emitter to provide the divided voltage to the buffer.

9. The control circuit of claim 2, wherein the signal generating unit includes:
a second capacitor charged or discharged by the current output from the current generating unit;
a charging or discharging switch disposed to be parallel to the second capacitor;
a first comparing unit comparing a preset third reference voltage and a voltage charged in the second capacitor with each other to control a switching operation of the charging or discharging switch; and
a second comparing unit comparing the charged voltage of the second capacitor and a preset fourth reference voltage to generate the pulse signal.

10. A power supply apparatus, comprising:
a power supplying unit switching a power input to a primary side to supply the power to a predetermined load connected to a secondary side electrically insulated from the primary side; and
a controlling unit applying a predetermined PWM signal to a dimming switch connected to an end of the load and controlling a switching frequency of the primary side based on a control voltage generated according to a feedback signal depending on the power supplied to the load and the PWM signal,
wherein a voltage variation amount of the control voltage is constantly maintained regardless of a duty of the PWM signal.

11. The power supply apparatus of claim 10, wherein the power supplying unit includes:
a switching unit including at least two switches connected in series between an input power terminal to which the input power is input and a ground;
a transforming unit transforming a voltage level of the power switched by the switching unit;
a first outputting unit stabilizing the power output from the transforming unit to output a preset first power; and
a second outputting unit stabilizing the power output from the transforming unit to output a preset second power.

12. The power supply apparatus of claim 11, wherein the transforming unit includes:
a resonance tank providing an inductor-inductor-capacitor (LLC) resonance operation of the switching unit; and
a transformer having a primary winding receiving the switched power of the switching unit, and a first secondary winding and a second secondary winding each forming a preset turns ratio with the primary winding and each outputting the first power or the second power.

13. The power supply apparatus of claim 11, wherein the power supplying unit further includes:
a rectifying and smoothing unit rectifying and smoothing an alternating current (AC) power; and
a power factor correcting unit performing a power factor correction on a direct current (DC) power from the rectifying and smoothing unit to supply the corrected DC power to the switching unit.

14. The power supply apparatus of claim 11, wherein the first power is supplied to at least one light emitting diode channel.

15. The power supply apparatus of claim 11, wherein the controlling unit controls the switching frequency according to a power state of the power supplying unit to control a power state of the first power and controls a switching duty to control a power state of the second power.
